(19) United States
(12) Patent Application Publication
(10) Pub. No.: US 2008/0244673 A1
(43) Pub. Date: Oct. 2, 2008

(54) Information processor and recording medium in which information processing program is recorded

(75) Inventor: Hideki Matsuo, Nagoya-shi (JP)

Correspondence Address: OLIFF & BERRIDGE, PLC, P.O. BOX 320850, ALEXANDRIA, VA, 22320-4850, US

(73) Assignee: BROTHER KOGYO KABUSHIKI KAISHA, NAGOYA-SHI (JP)

(21) Appl. No.: 12/007,020

(22) Filed: Jan. 4, 2008

(30) Foreign Application Priority Data
Mar. 29, 2007 (JP) 2007-087151

(51) Int. Cl. H04N 7/173

(52) U.S. Cl. 725/114

(57) ABSTRACT

In a request node for receiving content with a preset distribution completion time limit, which is distributed from a content node connected to the request node via a network, remaining time to the distribution completion time limit is detected. On the basis of the detected remaining time, a download speed necessary for distributing the content in the whole of the detected remaining time and completing the distribution within the remaining time is determined. Content request information including information indicative of the determined download speed is transmitted to the request node.

### CROSS REFERENCE TO RELATED APPLICATIONS

The present application claims priority from Japanese Patent Application NO. 2007-087151, which was filed on Mar. 29, 2007, the disclosure of which is herein incorporated by reference in its entirety.

### BACKGROUND OF THE INVENTION

1. Field of the Invention

The present invention belongs to the technical field of an information processor and a recording medium in which an information processing program for the information processor is recorded. More particularly, the invention belongs to the technical field of an information processor as a component of a network system constructed by connecting a plurality of information processors to each other via a network such as the Internet and to a recording medium in which an information processing program for the information processor is recorded.

2. Description of the Related Art

In recent years, the network technique of the Internet and the like is progressing remarkably. For example, studies on a content distribution system as disclosed in Japanese Patent Application Laid-Open No. 2006-197400 (patent literature 1) are being conducted.

In the content distribution system, for example, in the case of distributing content such as a movie, motion picture information or the like corresponding to the content is distributed (transmitted) from a content node that stores the motion picture information or the like to a request node operated by the user who wishes to watch the content. As for definition of the “content node”, the paragraph [0071] in the specification of the patent literature 1 can be referred to. As for definition of the “request node”, the paragraphs [0064] and [0065] in the specification of the patent literature 1 can be referred to.

With respect to distribution speed at the time of the distribution, for example, when the distribution is executed at a distribution speed at which distribution of content is not interrupted in the request node, there is no problem in practice.

On the other hand, content distributed by the content distribution system includes content with a time limit of distribution to a request node as the distribution destination. Concretely, for example, in the case of distributing motion picture information corresponding to a preview of a movie before release of the movie, distribution of the motion picture information of the preview to a request node operated by a person who wishes to watch the movie has to be completed by the release of the movie.

Distribution of content with the distribution completion time limit is often executed regardless of whether the content is actually viewed or not. In the related art of the patent literature 1 and the like, setting of speed of distributing content with the distribution completion time limit is not considered.

### SUMMARY OF THE INVENTION

When the speed of distributing content with the distribution completion time limit is set to be high more than necessary, problems occur such that the load on a network used for the distribution and the load on a content node as the distribution source increase.

On the other hand, when the distribution speed of the content decreases, another problem occurs such that distribution of the content cannot be completed by the distribution completion time limit.

The present invention has been achieved in view of the above problems. An object of the invention is to provide an information processor capable of reliably distributing even content with a distribution completion time limit to a request node as a distribution destination by the distribution completion time limit while lessening the load on a network used for distribution, and a recording medium in which an information processing program for the information processor is recorded.

In order to solve the above problems, the invention according to claim 1 relates to an information processor for receiving distribution information with a preset distribution completion time limit, which is distributed from a distribution-source information processor connected to the information processor via a network, comprising:

detecting means for detecting remaining time to the distribution completion time limit;

determining means for determining, on the basis of the detected remaining time, a distribution mode of the distribution information to be distributed, necessary to distribute the distribution information to be distributed to the information processor in the whole of the detected remaining time and to complete the distribution within the remaining time; and requesting means for transmitting request information including mode information indicative of the determined distribution mode and for requesting the distribution to the distribution-source information processor.

### BRIEF DESCRIPTION OF THE DRAWINGS

FIGS. 1A to 1C are diagrams for explaining the principle of the present invention. FIG. 1A is a timing chart for explaining the principle, FIG. 1B is a timing chart (I) showing a concrete example of the principle, and FIG. 1C is a timing chart (II) showing a concrete example of the principle.

FIG. 2 is a block diagram showing a schematic configuration of a node in an embodiment.

FIG. 3 is a flowchart showing a whole message process in the embodiment.

FIGS. 4A to 4C are flowcharts showing first to third examples, respectively, of a process of setting a timing of reviewing download speed in the embodiment.

FIGS. 5A to 5C are flowcharts showing first to third examples, respectively, of a state determining process in the embodiment.

FIGS. 6A and 6B are flowcharts (I) showing first and second examples, respectively, of download speed determining process in the embodiment.

FIGS. 7A and 7B are flowcharts (II) showing third and fourth examples, respectively, of the download speed determining process in the embodiment.

FIGS. 8A and 8B are flowcharts (III) showing fifth and sixth examples, respectively, of the download speed determining process in the embodiment.

### DETAILED DESCRIPTION OF THE PREFERRED EMBODIMENTS

Preferred embodiments for carrying out the present invention will now be described with reference to the drawings. The following embodiments relate to the case where the present invention is applied to a content distribution system similar to that in the invention disclosed in Japanese Patent Application Laid-Open No. 2006-197400 (patent literature 1) (that is, a so-called P2P (Peer-to-Peer) content distribution system for distributing content such as a movie and music).

### (I) Principle of the Invention

Prior to concrete description of the embodiments of the invention, the principle of the present invention will be described.

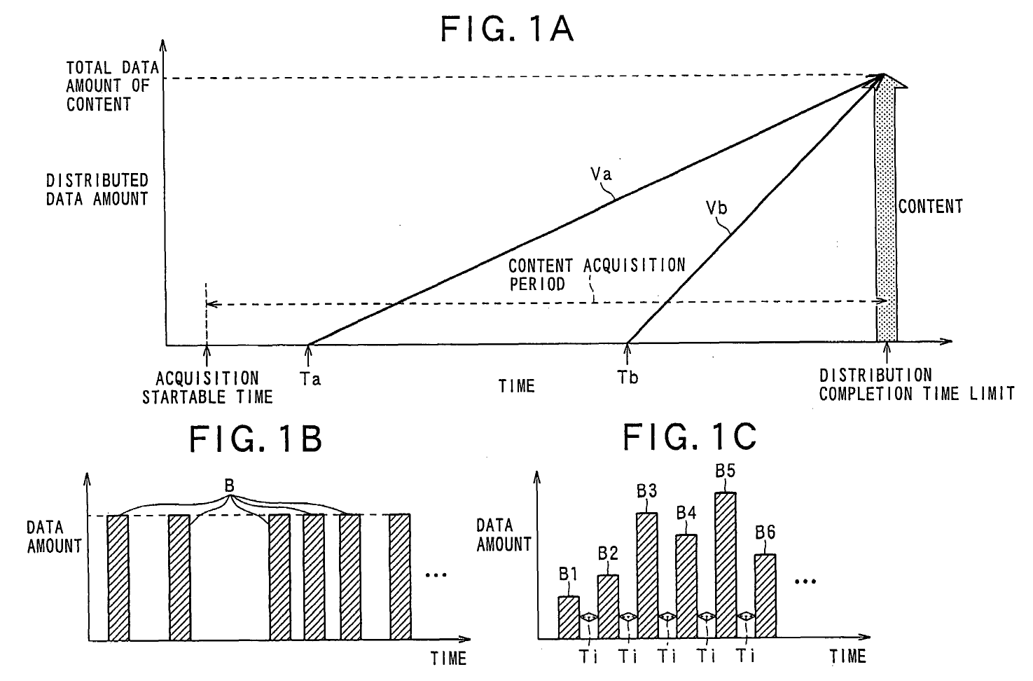

A hardware configuration of the content distribution system and a mechanism for distributing content data (a distributed hash table (DHT) used for transmitting/receiving a message necessary for distributing the content) applied in the present invention are basically similar to those of the content distribution system disclosed in the patent literature 1. Specifically, as the hardware configuration and the DHT in the content distribution system of the embodiment, concretely, a hardware configuration and a DHT described in paragraphs [0039] to [0072] and shown in FIGS. 1A, 1B, and 1C to FIGS. 5A, 5B, and 5C in Japanese Patent Application Laid-Open No. 2006-197400 (patent literature 1) are used.

As described above, distribution of content with predetermined distribution completion time limit is not considered in the invention disclosed in Japanese Patent Application Laid-Open No. 2006-197400 (patent literature 1).

On the other hand, in the present invention described below by the embodiment, as shown in FIG. 1A, a content acquisition period is set from the timing at which acquisition of content can start in each of nodes until the content distribution completion time limit. From an arbitrary timing in the period, acquisition of content in each request node starts.

Usually, the content acquisition starts at different timings (for example, timings Ta and Tb in FIG. 1A) in different request nodes for the conveniences of the users of the request nodes or the like. On the other hand, for the content itself to be distributed to any of the request nodes, the distribution completion time limit is set.

In the present invention, therefore, the remaining time from the actual acquisition start to the distribution completion time limit of the content is obtained in each of the request nodes. The distribution mode of the content is changed so as to maximally use the remaining time according to the length of time. Request information (a query which will be described later) to the content node as the distribution source of the content is transmitted so as to receive necessary content distributed in the distribution mode after the change.

As a concrete example of the distribution mode, as shown in FIG. 1A, distribution speeds (download speeds, for example, speeds Va and Vb shown in FIG. 1A) according to acquisition start timings (for example, timings Ta and Tb shown in FIG. 1A) are designated on the request node unit basis as shown in FIG. 1A, and the request information is transmitted.

As another example, the download speed may be substantially changed by equally dividing content to be distributed into a plurality of content blocks B on the basis of the data amount and changing the timings of requesting distribution of the divided content blocks B as shown in FIG. 1B.

As further another example, the download speed may be substantially changed by dividing the content into content blocks B1, B2, B3, B4, B5, B6, . . . of plurality of kinds of data amounts and requesting distribution of the divided content blocks B1, B2, B3, B4, B5, B6, . . . as shown in FIG. 1C in constant interval Ti.

The present invention satisfies both prevention of excessive load on a network due to concentration of distributions on a request node and prevention of miss of the distribution completion time limit.

An embodiment of the present invention based on the principle will now be described concretely with reference to FIGS. 1A to 1C to FIGS. 8A and 8B.

### (II) Embodiment

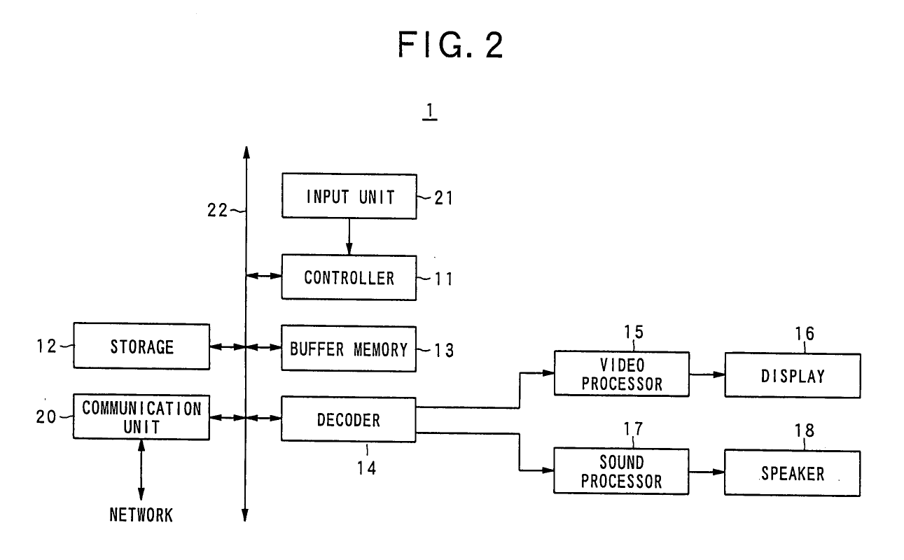

An embodiment of the present invention according to the principle shown in FIGS. 1A to 1C will be described hereinbelow with reference to FIG. 2 to FIGS. 8A and 8B. As described above, a hardware configuration, a DHT, a routing table, and the like in a content distribution system in the embodiment are basically similar to those in the content distribution system disclosed in Patent Literature 1. In the following embodiment, processes at a content distribution stage in the present invention will be mainly described.

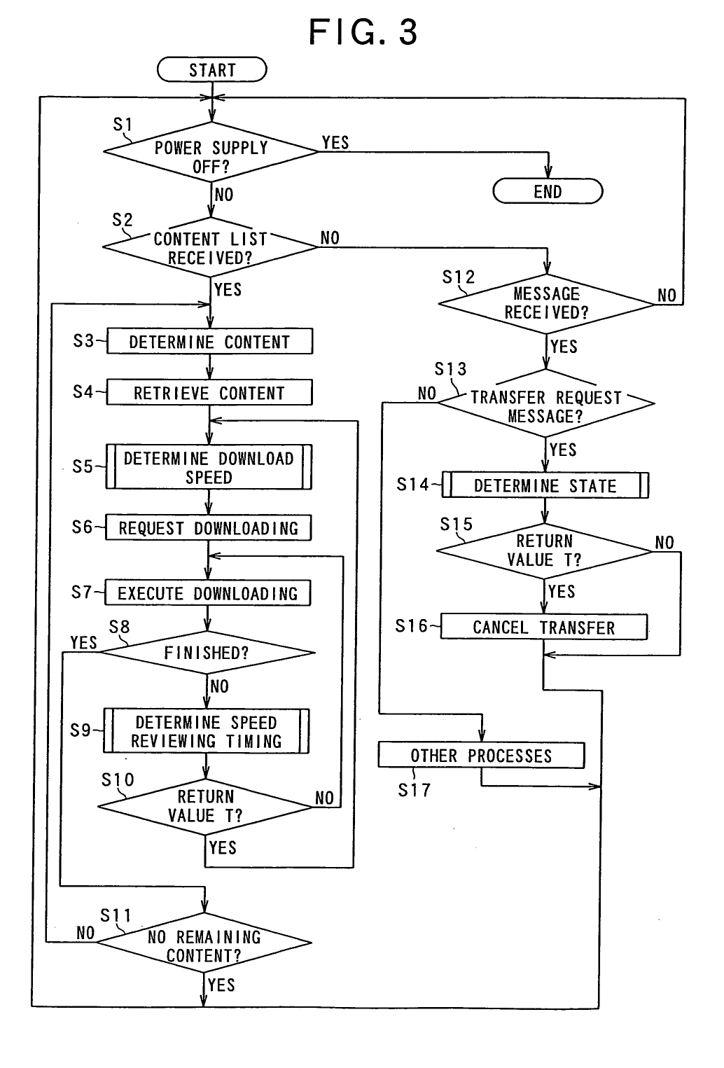

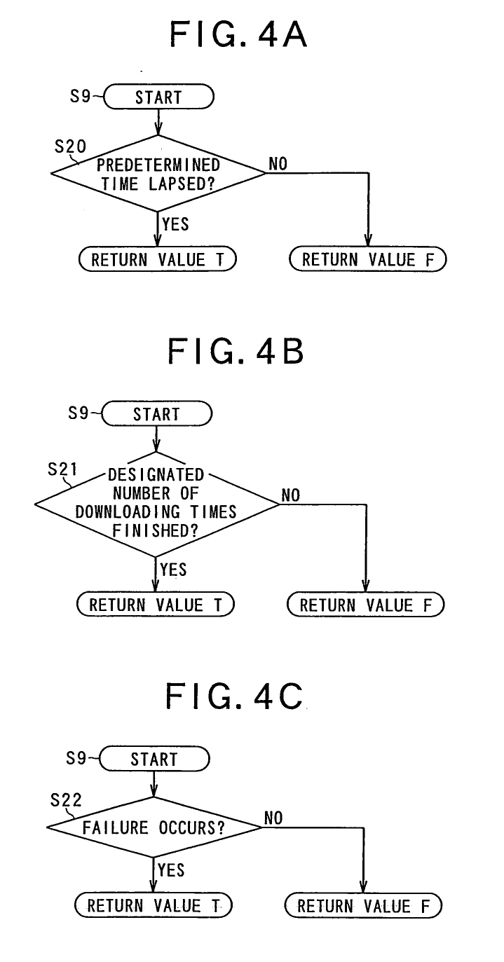

FIG. 2 is a block diagram showing a schematic configuration of a general node in the embodiment. FIG. 3 is a flowchart showing a message process as a whole in a request node in the embodiment. FIGS. 4A to 4C to FIGS. 8A and 8B show flowcharts each showing the details of the content distributing process in the embodiment at the request node.

The nodes in the embodiment basically have similar hardware configurations and perform different operations according to their roles in the content distribution system. The roles are, concretely, four roles; the role as a request node for inquiring the location of content to be distributed and requesting for distribution of the content, the role as a cache node for receiving queries from the request node and other nodes on a distribution path, the role as a root node for managing the content, and the role as a content node for holding content data corresponding to content to be distributed. With respect to definition of the “request node”, paragraphs [0064] and [0065] in the specification of the patent literature 1 can be referred to. With respect to definition of the “query”, for example, the paragraph [0065] in the specification of the patent literature 1 can be referred to. With respect to definition of the “cache node”, for example, the paragraphs [0071] and [0072] in the specification of the patent literature 1 can be referred to.

With respect to definition of the “root node”, the paragraph [0053] in the specification of the patent literature 1 can be referred to. Further, with respect to definition of the “content node”, the paragraph [0071] in the specification of the patent literature 1 can be referred to. Further, with respect to the details of the operations of the nodes having the above-described roles, for example, the paragraphs [0093] to [0115] in the specification of the patent literature 1 and the FIGS. 10 and 11 can be referred to.

As shown in FIG. 2, a node 1 in the embodiment has: a controller 11 as detecting means, determining means, undistributed information amount detecting means, undistributed information number detecting means, information processor detecting means, number of times detecting means, interruption detecting means, allotable time detecting means, and a computer constructed by a CPU having a computing function, a work RAM, a ROM for storing various data and programs, and the like; a storage 12 constructed by an HDD or the like for storing content data, index information (with respect to the index information, the paragraph [0071] in the specification of the patent literature 1 can be referred to), the DHT, other programs, and the like (there is also a node 1 which does not store the content data); a buffer memory 13 for temporarily storing received content data; a decoder 14 for decoding (decompressing, decrypting, or the like) video data (video information), audio data (audio information), and the like included in the content data; a video processor 15 for performing a predetermined drawing process on the decoded video data or the like ad outputting the resultant as a video signal; a display 16 such as a CRT (Cathode Ray Tube) or liquid crystal display for displaying a video image on the basis of the video signal output from the video processor 15; a sound processor 17 for D-A (Digital-to-Analog) converting the decoded audio data to an analog audio signal, amplifying the analog audio signal by an amplifier, and outputting the amplified signal; a speaker 18 for outputting the audio signal output from the sound processor 17 as a sound wave; a communication unit 20 as requiring means for performing communication control on information to/from another node 1 via a network; and an input unit (such as a keyboard, a mouse, an operation panel, and the like) 21 for receiving an instruction from the user and supplying an instruction signal according to the instruction to the controller 11. The controller 11, the storage 12, the buffer memory 13, the decoder 14, and the communication unit 20 are connected to each other via a bus 22.

By executing the various programs stored in the storage 12 or the like, the CPU included in the controller 11 controls the whole node 1 as any one of the request node, the cache node, the root node, and the content node.

In the storage 12, a routing table as shown in FIG. 4D of the patent literature 1 is stored in a nonvolatile manner and is used for transmitting/receiving the message and distributing content.

The message process (including a process of determining download speed in the embodiment) of the content distribution system, executed mainly by the controller 11 in the node 1 of the embodiment will be concretely described with reference to FIG. 3 to FIGS. 8A and 8B.

### (III) General Configuration of Message Process

First, the general configuration of the message process in the embodiment will be described with reference to FIG. 3. As a precondition of the message process described below, it is assumed that a content node for storing content data corresponding to content to be distributed in the embodiment in response to a query from the request node is already specified by the request node.

As shown in FIG. 3, as the message process executed in each of the nodes 1, first, the controller 11 determines whether the power supply switch of the node 11 itself is turned off or not (step S1). When the power supply switch is off (YES in step S1), the message process is finished. On the other hand, when the power supply switch is not off (NO in step S1), the controller 11 determines whether or not list information corresponding to a content list indicative of content which can be obtained from the already specified content node from the root node or the cache node (step S2).

When the list information has been received (YES in step S2), the controller 11 determines content to be acquired by using the received content list (step S3) and transmits a query for searching the content node which stores the determined content into the content distribution system (step S4). In the step S4, when it is necessary to retrieve a plurality of content nodes in a download speed determining process which will be described later, the controller 11 transmits a query indicative of retrieval of content nodes of the number which have to be retrieved.

Next, the controller 11 of the request node determines the download speed corresponding to the retrieved content (or the data amount of the content block B corresponding to the download speed and the required interval (refer to FIG. 1B) or the data amount of each of the content blocks B1, B2, B3, B4, B4, B6, . . . corresponding to the download speed and the predetermined required interval Ti (refer to FIG. 1C), those three download speeds will be called download speed) (step S5). The process of step S5 will be described in detail later.

The controller 11 of the request node generates and sends a query including the information such as the determined download speed and requesting downloading of content into the content distribution system (step S6). After that, in response to the query, downloading of the content is started (step S7).

During execution of the downloading, the controller 11 always monitors completion of the downloading of the content (step S8). When the downloading is completed (YES in step S8), the controller 11 determines whether the downloading has been completed on all of the content to be downloaded or not (step S11). When the downloading of all of the content has been completed (YES in step S11), the controller 11 returns to the step S1 and repeats the above-described series of processes. When it is determined in the step S11 that there is still content to be downloaded (NO in step S11), the controller 11 returns to the step S3 and repeats the subsequent processes.

On the other hand, when it is determined in the step S8 that the downloading has not been completed (NO in step S8), the controller 11 determines whether the download speed for the content which is present being downloaded is reviewed or not at present (step S9). The process in the step S9 will be also descried in detail later.

The controller 11 determines whether the “return value” as a result of determination in the step S9 is “T (True)” or not (step S10). When the return value is “T” (YES in step S10), the controller 11 determines that it is the timing to review the download speed and moves to the process in the step S5. On the other hand, when the return value is not “T”, that is, the return value is “F (False)” (NO in step S10), the controller 11 determines that it is not the timing of reviewing the download speed at present, maintains the present download speed, and continuously execute the downloading (step S7).

By repeating the processes in the steps S5 to S10 every timing of reviewing the download speed, the download speed is optimized as shown in FIGS. 1A to 1C, and downloading of necessary content is completed by the distribution completion time limit.

When the controller 11 returns to the determination in the step S2 and it is determined that necessary list information has not been received (NO in step S2), the controller 11 determines whether a new message is received or not via the network and the communication unit 20 (step S12).

When it is determined in the step S12 that no new message is received (NO in step S12), the controller 11 returns to the step S1 and repeats the series of processes. On the other hand, when a new message is received (YES in step S12), the controller 11 determines that the received message is a transfer request message from another node 1 (that is, a query message to be transferred to an upper-order node 1, a reply message to be transferred to a lower-order node 1, or the like) (step S13). When the received message is not the transfer request message (NO in step S13), the controller 11 executes another process which is preliminarily defined in the node 1 in correspondence with the received message (step S17), returns to the step S1, and repeats the series of processes.

On the other hand, when it is determined in step S13 that the received message is the transfer request message (YES in step S13), the controller 11 performs a state determining process of determining whether or not priority should be placed on downloading of content to be obtained (see the step S7) in the request node in response to transfer of the message at that time point (step S14). The process in the step S14 will be also described later in detail.

The controller 11 determines whether the return value as a result of the process in the step S14 is “T” or not (step S15). When the return value is “T” (YES in step S15), the controller 11 determines that priority should be placed on downloading of the content over transfer of the received message at that time point and interrupts the message transferring process (step S16). The controller 11 returns to the step S1 and repeats the series of processes.

On the other hand, when it is determined in the step S15 that the return value is not “T”, that is, the return value is “F” (NO in step S15), the controller 11 returns to the step S1 and repeats the series of processes.

The details of the processes in the steps S9, S14, and S9 shown in FIG. 3 will be described concretely with reference to FIGS. 4 to 8.

### (A) Details of Process in Step S9

For convenience of explanation, the details of the process in the step S9 will be described first with reference to FIGS. 4A to 4C. FIGS. 4A to 4C are flowcharts each showing concrete processes which can be employed as the process in the step S9.

### (a) First Example

As determination in the step S9 of whether it is the timing of reviewing the download speed or not, for example, as shown in FIG. 4A, the controller 11 determines whether a predetermined period (for example, 600 seconds) has elapsed or not (step S20). In the case where the predetermined period has elapsed (YES in step S20), the controller 11 sets the return value to “T” and reviews the download speed. In the case where the predetermined period has not elapsed (NO in step S20), the controller 11 sets the return value to “F” and maintains the present download speed.

### (b) Second Example

As another example, as shown in FIG. 4B, the controller 11 determines whether the downloading of a pre-designated number of pieces of content has been finished or not (step S21). In the case where the downloading of the designated number of pieces of content has been finished (YES in step S21), the controller 11 sets the return value to “T” and reviews the download speed. When the designated number of pieces of downloading has not been finished (NO in step S21), the controller 11 sets the return value to “F” and maintains the present download speed. Preferably, the “designated number of pieces” in this case is set to, for example, the number corresponding to 20% of the total number of pieces of content to be downloaded.

### (c) Third Example

As further another example, as shown in FIG. 4C, the controller 11 determines whether or not any failure (such as interruption in the path caused by turn-off of another node 1 in the path) occurs in downloading which is presently executed (step S22). In the case where a failure occurs (YES in step S22), the controller 11 sets the return value to “T”. When the failure as a trigger to review the download speed does not occur (NO in step S22), the controller 11 sets the return value to “F” and maintains the present download speed.

### (B) Details of Process in Step S14

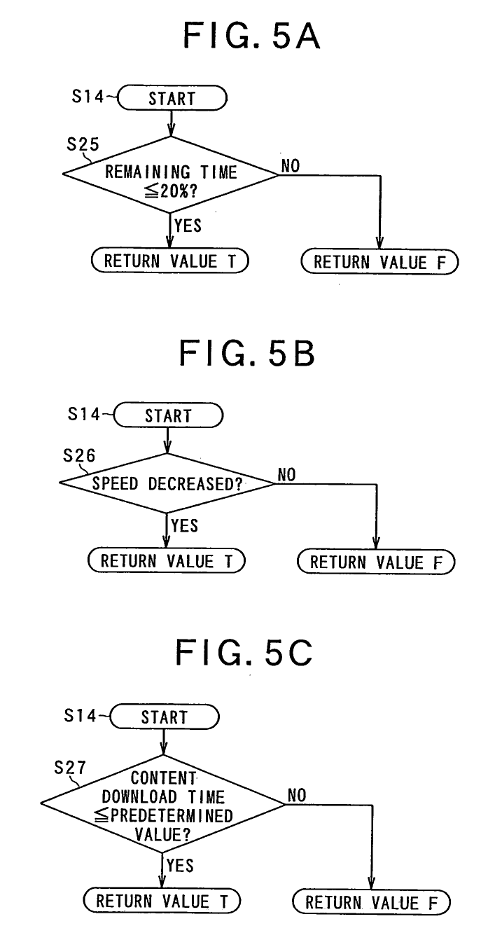

The details of the step S14 will be described with reference to FIGS. 5A to 5C. FIGS. 5A to 5C are flowcharts each showing a concrete process which can be employed as the process in step S14.

### (a) First Example

In the process of determining the download state as the step S14, for example, as shown in FIG. 5A, the controller 11 detects the remaining time to the distribution completion time limit of the content. The controller 11 determines whether or not the remaining time is equal to, for example, 20% of the whole content acquisition period (see FIG. 1A) or less (step S25). When the remaining time is 20% or less (YES in step S25), the controller 11 sets the return value to “T” and places priority on the downloading process to other message transferring processes. When the remaining time is longer than 20% (NO in step S25), the controller 11 sets the return value to “F” and determines that it is unnecessary to place priority on the downloading process.

### (b) Second Example

As another example, for example, as shown in FIG. 5B, the controller 11 determines whether or not the actual download speed at present is equal to or less than preset threshold speed (step S26). When the download speed is equal to or less than the threshold speed (YES in step S26), the controller 11 sets the return value to “T”, places priority on the downloading process to the process of transferring another message, and increases the speed. When the download speed is higher than the threshold speed (NO in step S26), the controller 11 sets the return value to “F” and determines that it is unnecessary to place priority on the downloading process. Preferably, the “threshold speed” in this case is set to, for example, a threshold speed corresponding to 30% of a bandwidth (maximum distribution speed) in the network to which the request node is physically connected via the communication unit 20.

### (c) Third Example

As further another example, for example, as shown in FIG. 5C, the controller 11 detects the remaining time to the distribution completion time limit of the content. The controller 11 calculates download time which can be designated to the content as download time per piece of content to be downloaded from the number of pieces of content to be subsequently downloaded and the remaining time, and determines whether the calculated download time is equal to or shorter than the download time (step S27). When the download time is equal to or shorter than the threshold (YES in step S27), the controller 11 sets the return value to “T” and places priority on the downloading process to the process of transferring another message. When the download time is longer than the threshold (NO in step S27), the controller 11 sets the return value to “F” and determines that it is unnecessary to place priority on the downloading process. Preferably, the “threshold of the download time” is, for example, a threshold corresponding to 20% of the remaining time detected.

### (C) Details of Process in Step S5

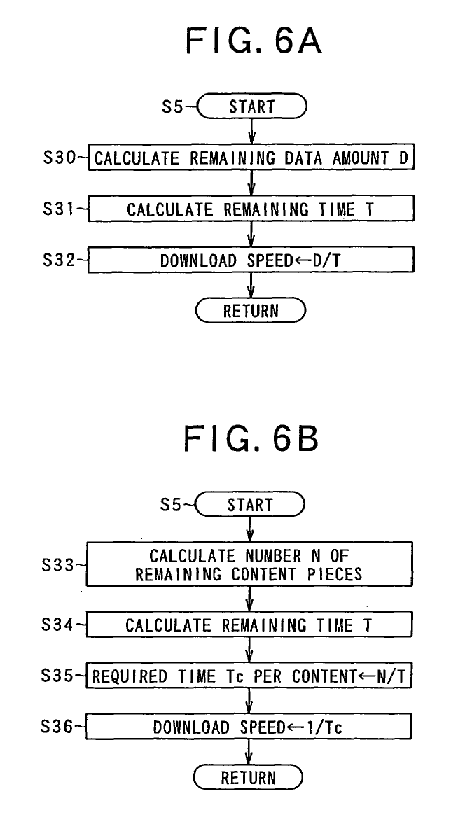

Finally, the details of the process in the step S5 will be described with reference to FIGS. 6A and 6B to FIGS. 8A and 8B. FIGS. 6A and 6B to FIGS. 8A and 8B are flowcharts each showing a concrete process which can be employed as the process in step S5.

### (a) First Example

In the process of determining the download speed as the step S5, for example, as shown in FIG. 6A, the controller 11 calculates the remaining data amount D in the downloading of the content (step S30). The controller 11 calculates the remaining time T to the distribution completion time limit of the content (step S31). The controller 11 determines the download speed at that time point by a value obtained by dividing the calculated data amount D by the remaining time T (step S32).

### (b) Second Example

As another example, as shown in FIG. 6B, the controller 11 calculates the number N of pieces of content which is not obtained at that time point among all of the content pieces to be obtained by the request node (on assumption that the distribution completion time limit of all of the content pieces is the same) (step S33). The controller 11 similarly calculates the remaining time T to the distribution completion time limit of each of the content pieces (step S34). The controller 11 sets the value obtained by dividing the calculated number N of remaining content pieces by the remaining time T as download time Tc for one of the remaining content pieces (step S35). The controller 11 determines the inverse number (1/Tc) of the download time as the download speed at that time point (steps S35 and S36).

### (c) Third Example

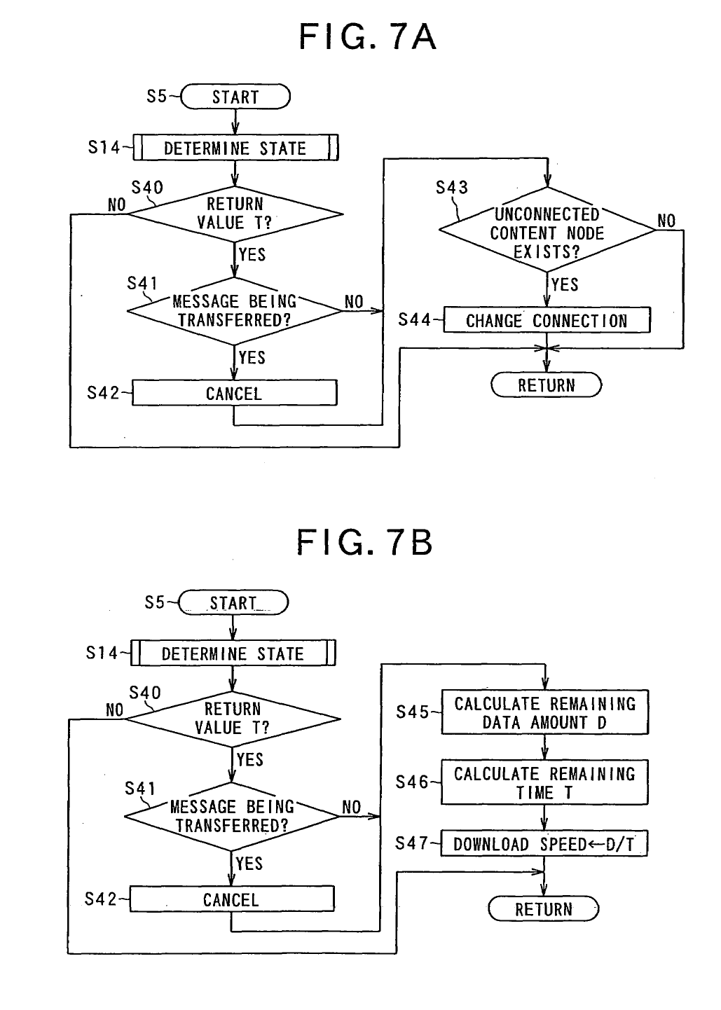

Further another example will be described with reference to FIG. 7A. As a precondition of the download speed determining process shown in FIG. 7A, it is assumed that a plurality of content nodes are retrieved at the stage of the content retrieving process (step S4) shown in FIG. 3. Preferably, as the number of content nodes retrieved, generally, 10 to 20 content nodes are retrieved. In practice, the embodiment can be executed with five or less content nodes.

As the further another example, as shown in FIG. 7A, the controller 11 executes the state determining process related to the process in the step S14 (step S14) and, after that, determines whether the return value as a result of the determination in the step S14 is “T” or not (step S40). When the return value is “F” (that is, a state where downloading of the content does not have priority over transfer of another message) (NO in step S40), the controller 11 shifts to the process in the step S6 shown in FIG. 3. On the other hand, when the return value is “T” (that is, priority is placed on downloading of the content over transfer of another message) (YES in step S40), the controller 11 determines whether the another message is being transferred (that is, the another message is being uploaded or downloaded) or not (step S41).

When the another message is not being transferred (NO in step S41), the controller 11 shifts to the process in step S43 which will be described later. On the other hand, when another message is being transferred (YES in step S41), the controller 11 immediately stops the transfer (step S42). When it is determined in the step S41 that another message is not being transferred (NO in step S41) or after the process of the step S42, the controller 11 determines whether another content node to which the request node is not connected exists in the content distribution system or not at present (step S43).

When an unconnected content node exists (YES in step S43), the controller 11 newly starts downloading of content from the unconnected content node (step S44) and shifts to the process in the step S6 shown in FIG. 3.

On the other hand, when it is determined in the step S43 that there is no unconnected content node anymore (NO in step S43), the controller 11 determines that downloading of the content node being connected at present is continued, and shifts to the process in the step S6 in FIG. 3.

### (d) Fourth Example

Further another example will be described with reference to FIG. 7B. In FIG. 7B, the same step numbers are designated to processes similar to those in FIG. 7A and description of their details will not be repeated.

As another example, as shown in FIG. 7B, the controller 11 executes the state determining process related to the process in the step S14 (step S14). Further, the processes in the steps S40 to S42 described with reference to FIG. 7A are executed.

Next, the controller 11 calculates the remaining data amount D in the downloading of the content (step S45). The controller 11 calculates the remaining time T to the distribution completion time limit of the content (step S46). The controller 11 determines, as the download speed at that time point, a value obtained by dividing the calculated data amount D by the remaining time T (sep S47), and shifts to the process in the step S6 shown in FIG. 3.

### (e) Fifth Example

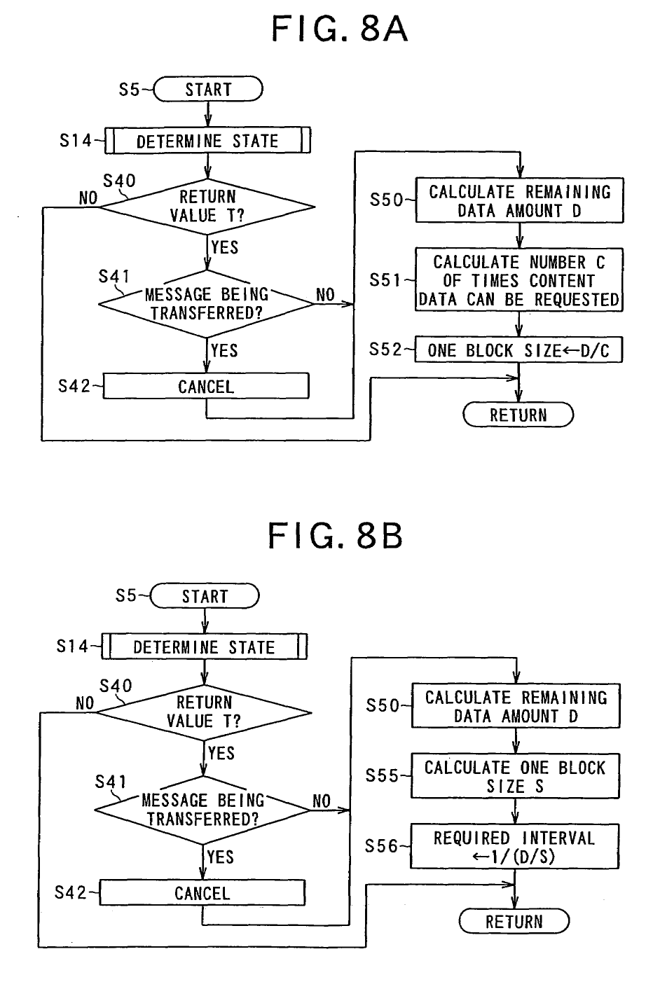

Further another example will be described with reference to FIG. 8A. In FIG. 8A, the same step numbers are designated to processes similar to those in FIG. 7A and description of their details will not be repeated.

The example shown in FIG. 8A relates to the download speed determining process corresponding to the principle described with reference to FIG. 1C.

As the another example, as shown in FIG. 8A, the controller 11 executes the state determining process related to the process in the step S14 (step S14). After that, the controller 11 executes the processes in the steps S40 to S42 described using FIG. 7A.

Next, the controller 11 calculates the data amount D of content which is not obtained yet at that time point among all of content pieces to be obtained by the request node (on assumption that the distribution completion time limit of all of content pieces is the same) (step S50).

The controller 11 performs calculation by setting the number C of times the content data can be requested by the distribution completion time limit of each of the content pieces as, for example, about 1,000 times (step S51). For the acquisition request, since the content node has been already retrieved, it is unnecessary to transmit a query message for the request from the request node. As the acquisition request, concretely, for example, a designation message of designating a necessary part in content data corresponding to content desired to be obtained by the number of bytes, the byte number, or the like is transmitted. The number C of times refers to the number of times of sending the designation message.

Based on the above, the controller 11 sets the value obtained by dividing the calculated remaining data amount D by the number C of requestable times as the data amount of a content block Bx (x=1, 2, 3, 4, . . . ) in the remaining content at that time point (step S52). The controller 11 divides the content into the content blocks Bx of the data amounts, and shifts to the process in the step S6 shown in FIG. 3 in order to continue the downloading of content.

### (f) Sixth Example

Finally, further another example will be described by using FIG. 8B. In FIG. 8B, the same step numbers are designated to processes similar to those in FIG. 7A and description of their details will not be repeated.

The example shown in FIG. 8B relates to the download speed determining process corresponding to the principle described with reference to FIG. 1B.

As the another example, as shown in FIG. 8B, the controller 11 executes the state determining process related to the process in the step S14 (step S14). After that, the controller 11 executes the processes in the steps S40 to S42 described using FIG. 7A.

Next, the controller 11 calculates the data amount D of content which is not obtained yet at that time point among all of content pieces to be obtained by the request node (on assumption that the distribution completion time limit of all of content pieces is the same) (step S50).

The controller 11 performs calculation by setting the data amount S of the content block B in the request for obtaining the content data (refer to the “fifth example”) by the distribution completion time limit as, for example, about 512 kilobytes (step S55). The controller 11 sets the inverse number (the dimension is “time”) of a value obtained by dividing the calculated remaining data amount D by the data amount S of the content block B as the query transmission interval at that time point (corresponding to the predetermined request interval Ti in FIG. 1C) (step S56). The controller 11 moves to the process in step S6 shown in FIG. 3 in order to transmit queries in the interval.

As described above, by the operations of the request node in the embodiment, content is distributed for the whole remaining time by the distribution completion time limit, a distribution mode necessary to complete distribution within the remaining time is determined, and a query indicative of the determined distribution mode is transmitted. Therefore, by effectively using the whole remaining time, while lessening the load on the network of distribution, the distribution completion time limit is prevented from being missed, and necessary content can be reliably distributed by the distribution completion time limit.

Therefore, even content with preset distribution completion time limit can be reliably distributed to the node 1 (request node) by the distribution completion time limit while lessening the load on the network used for distribution.

Since new download speed is re-determined under a predetermined condition and a query for the determined speed is transmitted again, even when the distribution mode for completing distribution by the distribution completion time limit changes due to a change in the situation of the network or the like, the distribution can be reliably completed by the distribution completion time limit.

Further, except for content distribution, when the process of transferring another message is executed, whether the process of transferring the another message is interrupted or not is determined. When the process is to be interrupted, the process of transferring the another message is interrupted, and priority is placed on distribution of content. As necessary, priority can be placed on distribution of content, and the distribution can be completed by the distribution completion time limit.

In the first example of the step S9 (see FIG. 4A), new download speed is re-determined every predetermined period. Thus, distribution can be completed by the distribution completion time limit so as to follow a change in the state of the network or the like.

In the second example of the step S9 (see FIG. 4B), new download speed is re-determined each time distribution of the preset data amount is completed. Thus, the distribution can be completed reliably by the distribution completion time limit so as to follow a change in the state of the network or the like.

Further, in the third example of the step S9 (see FIG. 4C), when a failure occurs in the network as the distribution path, new download speed is re-determined. Consequently, the distribution can be reliably completed by the distribution completion time limit so as to follow a change in the state of the network or the like.

Further, in the first example of the step S14 (see FIG. 5A), when remaining time to the detected distribution completion time limit becomes the preset ratio (for example, 20%) of the period to the distribution completion time limit, it is determined that the process of transferring another message is interrupted. Consequently, by interrupting the process of transferring another message when the remaining time becomes actually short, the process of transferring the another message is efficiently interrupted and priority can be placed on content distribution.

Further, in the second example of the step S14 (see FIG. 5B), when the actual content download speed becomes the preset threshold speed or less, it is determined that distribution of content should be executed reversibly and promptly, and the process of transferring another message is interrupted. Consequently, by efficiently interrupting the process of transferring another message, priority can be placed on distribution of content.

Further, in the third example of the step S14 (see FIG. 5C), when content time corresponding to any of content becomes the preset threshold time or less, it is determined that distribution of content should be executed reversibly and promptly, and the process of transferring another message is interrupted. Consequently, by efficiently interrupting the process of transferring another message, priority can be placed on distribution of content.

Further, in the first example of the step S5 (see FIG. 6A), by dividing the data amount D of content which is not yet obtained by the remaining time T, the download speed after that is determined and a query is transmitted. Thus, while minimizing the load on the network, necessary content can be distributed by the distribution completion time limit.

In the second example of the step S5 (see FIG. 6B), by dividing the remaining time T by the number of pieces of content pieces which are not yet obtained, the required time per content after that is determined, and a query is transmitted to complete the distribution of content in correspondence with the required time. Thus, while minimizing the load on the network, necessary content can be distributed by the distribution completion time limit.

In the third example of the step S5 (see FIG. 7A), when there is an unused content node, a query is transmitted so that content is distributed from a plurality of content nodes including the unused content node. Thus, while minimizing the load on the network, necessary content can be distributed by the distribution completion time limit.

In the fifth example of the step S5 (see FIG. 8A), the data amount obtained by dividing the data amount D of content which is not yet obtained by the number C of times the content block Bx can be requested to be distributed is determined as the data amount of one content block Bx after that. Thus, while minimizing the load on the network, necessary content can be distributed by the distribution completion time limit.

In the sixth example of the step S5 (see FIG. 8B), the data amount D of content which is not yet obtained is divided by the information amount of one content block B. After that, the inverse number of the obtained value is set as a transmission interval. The transmission interval is determined as the required interval Ti of content block B. Transmission of a query of distributing the content block B is transmitted at the required intervals Ti is repeated. Thus, while minimizing the load on the network, necessary content can be distributed by the distribution completion time limit.

By recording a program corresponding to each of the flowcharts of FIGS. 3 to 8 on an information recording medium such as a flexible disk or a hard disk, or obtaining the program via the Internet or the like and recording it, and reading and executing the program by a general computer, the computer can be utilized as the controller 11 in the embodiment.

As described above, the present invention can be utilized in the fields of a so-called P2P type content distribution system. In particular, when the invention is applied to the fields of a content distribution system which distributes content by a distribution completion time limit, remarkable effects can be obtained.

The present invention is not confined to the configuration listed in the foregoing embodiments, but it is easily understood that the person skilled in the art can modify such configurations into various other modes, within the scope of the present invention described in the claims.

What is claimed is:

1. An information processor for receiving distribution information with a preset distribution completion time limit, which is distributed from a distribution-source information processor connected to the information processor via a network, comprising:
detecting means for detecting remaining time to the distribution completion time limit;
determining means for determining, on the basis of the detected remaining time, a distribution mode of the distribution information to be distributed, necessary to distribute the distribution information to be distributed to the information processor in the whole of the detected remaining time and to complete the distribution within the remaining time; and
requesting means for transmitting request information including mode information indicative of the determined distribution mode and for requesting the distribution to the distribution-source information processor.

2. The information processor according to claim 1,
wherein the distribution mode is distribution speed of the distribution information in the network,
the information processor further comprises undistributed information amount detecting means for detecting an amount of undistributed information in the distribution information to be distributed as an undistributed information amount,
the determining means determines speed obtained by dividing the detected undistributed information amount by the remaining time as the distribution speed, and
the requesting means transmits the request information including the mode information indicative of the determined distribution speed to the distribution-source information processor.

3. The information processor according to claim 1,
wherein the distribution information is composed of a plurality of pieces of partial distribution information,
the distribution mode is required distribution time of the distribution information in the network,
the information processor further comprises undistributed information number detecting means for detecting the number of pieces of undistributed partial distribution information in the distribution information to be distributed as the number of pieces of undistributed information,
the determining means determines time obtained by dividing the detected number of undistributed information pieces by the remaining time as the required distribution time of each of the partial distribution information undistributed, and
the requesting means transmits the request information for completing distribution of the undistributed partial distribution information within the determined required distribution time to the distribution-source information processor.

4. The information processor according to claim 1,
wherein the distribution information is distributed from a plurality of distribution-source information processors,
the distribution mode indicates the distribution-source information processor as an actual distribution source of the distribution information,
the information processor further comprises information processor detecting means for detecting the distribution-source information processor which is not actually used for distribution of the distribution information,
the determining means determines the detected information processor as a new distribution source, and
the requesting means transmits the request information to each of the distribution-source information processors as an actual distribution source so that the distribution information is distributed from each of the plurality of distribution-source information processors including the determined new distribution-source information processor.

5. The information processor according to claim 1,
wherein the distribution mode denotes an information amount of one distribution information block obtained by dividing the distribution information,
the information processor further comprises:
undistributed information amount detecting means for detecting, as an undistributed information amount, an information amount of an undistributed part of the distribution information to be distributed; and
number-of-times detecting means for detecting the number of requestable times as the number of times for which distribution of the distribution information block can be requested by the distribution completion time limit,
the determining means determines a value obtained by dividing the detected undistributed information amount by the detected number of requestable times as the information amount of one block, and
the requesting means transmits the request information including the determined information amount of one block as the mode information and requesting distribution of the distribution information block having the information amount of one block to the distribution-source information processor.

6. The information processor according to claim 1,
wherein the distribution mode is a transmission interval at the time of transmitting the request information for requesting distribution of a distribution information block obtained by dividing the distribution information to the distribution-source information processor at a plurality of times,
the information processor further comprises undistributed information amount detecting means for detecting, as an undistributed information amount, an information amount of an undistributed part of the distribution information to be distributed,
the determining means determines, as the transmission interval, an inverse of a value obtained by dividing the detected undistributed information amount by an information amount which is preset as an amount of one distribution information block, and
the requesting means repeats transmitting the request information for requesting distribution of the distribution information of one distribution information block to the distribution-source information processor at the determined transmission intervals.

7. The information processor according to claim 1,
wherein the determining means re-determines the new distribution mode on the basis of the detected remaining time at present so that the distribution is completed by the distribution completion time limit, and
the requesting means re-transmits the request information including the mode information indicative of the re-determined new distribution mode to the distribution-source information processor.

8. The information processor according to claim 7,
wherein the determining means repeats re-determination of the distribution mode at every preset period.

9. The information processor according to claim 7,
wherein the determining means repeats re-determination of the distribution mode each time distribution of the distribution information of the preset amount is completed.

10. The information processor according to claim 7,
wherein when a failure occurs in the distribution in the network as a distribution path of the distribution information, the determining means repeats re-determination of the distribution mode.

11. The information processor according to claim 1, further comprising:
interruption determining means for determining whether or not transmission/reception of information other than the distribution information is interrupted when the transmission/reception is executed in the network; and
interrupting means for interrupting the transmission/reception when the interruption determining means determines that the transmission/reception is to be interrupted.

12. The information processor according to claim 11,
wherein when the detected remaining time becomes equal to or less than a preset ratio for a period of time since distribution of the distribution information becomes possible until the distribution completion time limit, the interruption determining means determines that the transmission/reception is interrupted.

13. The information processor according to claim 11,
wherein when the actual distribution speed of the distribution information becomes equal to or less than a preset threshold distribution speed, the interruption determining means determines that the transmission/reception is interrupted.

14. The information processor according to claim 11,
wherein the distribution information is composed of a plurality of pieces of partial distribution information,
the information processor comprises allotable time detecting means for detecting allotable time as time which can be allotted to distribution of the partial distribution information undistributed, and
the interruption determining means, when the allotable time corresponding to any of the partial distribution information pieces becomes equal to or less than preset threshold time, determines that the transmission/reception is interrupted.

15. A recording medium in which an information processing program for making a computer function as the information processor of claim 1 is recorded so as to be readable by the computer.
